(19) United States
(12) Patent Application Publication
(10) Pub. No.: US 2007/0094325 A1
(43) Pub. Date: Apr. 26, 2007

(54) Hybrid peer-to-peer data communication and management

(75) Inventors: Ronald H. Ih, Los Altos, CA (US); William T. Sumerlin JR., Pleasanton, CA (US); Derek Gaw, Seattle, WA (US); Sung Hwan Chung, Stanford, CA (US)

Correspondence Address: KOKKA & HSU, PC, 1001 N. RENGSTORFF AVE., SUITE 250, MOUNTAIN VIEW, CA, 94043-1748, US

(73) Assignee: Nucleoid Corp., Los Altos, CA (US)

(21) Appl. No.: 11/255,624

(22) Filed: Oct. 21, 2005

(51) Int. Cl. G06F 15/16

(52) U.S. Cl. 709/203

(57) ABSTRACT

Hybrid peer-to-peer data communication and management is described, including querying a plurality of elements in an environment for state data, the state data describes a state of the environment and an activity occurring in the environment, receiving the state data from one or more of the plurality of elements in response to the querying, analyzing the state data to determine an environmental change, the updated state data is generated describing the environmental change, and using the updated state data to modify the environment by dynamically allocating the plurality of elements to process a simulation, the plurality of elements being dynamically allocated based on available processing capacity provided by the plurality of elements.

### FIELD OF THE INVENTION

The present invention relates generally to software and computer gaming. More specifically, hybrid peer-to-peer data communication and management is described.

### BACKGROUND

In computer gaming, data communication (i.e., sending, receiving, forwarding, or transfer data packets, frames, segments, or the like, between various nodes or endpoints) can be implemented using standalone or distributed game system architectures. There are various types of games including strategy, first-person player (e.g., combat, driving, flight simulation, city simulation, historical simulation, and the like), turn-based role-playing, and others. Some conventional games are installed and run on a client (i.e., a computer program or application intended to execute on a single computer or host), allowing a user to play (i.e., interact with the game logic) in a “standalone” mode. Another conventional game form is interactive online or distributed gaming, which involves more than one client connected to other clients running a similar game application or client that enables multiple players to play and interact simultaneously. In some conventional distributed games, large numbers of players may be involved in a massive multi-player online game (“MMOG”). Players can play against each other, with each other or independently of one another. However, a player may or may not be aware of other players in a common game space.

Conventional MMOG are currently implemented using client/server network architectures and techniques that are limited by several factors. Traditionally, personal computer (“PC”) games use a client/server architecture, while “console” games use either a client/server or a peer-to-peer architecture depending on the type of game and the performance requirements of the game. These factors include the topology of a network (e.g., peer-to-peer, client-server, Ethernet, and the like), number of clients involved in the game play, available bandwidth (internal and external to a network), network data transmission rates, network conditions (e.g., backbone congestion, network component failures, transmission latencies, unavailable routers, servers, and other network equipment), type and amount of data traffic required for enabling game play, the number of physics engines used for the game (i.e., processing applications or facilities that perform functions such as determining virtual conditions and characteristics in a game environment based on predicting actual physical outcomes, such as the motion of a bullet, weather patterns in a virtual location, the effect of various events and activities upon players' avatars or characters, environmental game conditions, and the like), game server availability, and the like. In conventional MMOG systems, large numbers of clients are completely reliant upon a smaller number of game servers (e.g., computers or servers that act as central data processing facilities for performing simulations that enable a game environment and state), which may create substantial latencies in real-time games as the number of users increases. As the number of users increases and inputs and actions increase, data traffic and processing load on central servers increases geometrically. Subsequently, network bandwidth and game server and physics engine availability become limited and can cause game failure or delays, thus reducing the attractiveness of a MMOG to users.

A large number of users can create large amounts of data traffic that can become congested on a network if many clients are attempting to communicate with a smaller number of game servers, which causes game play to slow. Further, large numbers of processing functions can be slowed or stopped if game servers and physics engines become unavailable to perform simulations or physics calculations. Still further, available network bandwidth may be insufficient to handle large amounts of traffic for MMOG game play, thus diminishing the user experience, commercial success, and attractiveness of games, reducing incentive for individuals and organizations to develop innovative technologies related to MMOG. The current solution is to limit the number of players that are permitted to play on a given server cluster.

Other conventional MMOG and online games use peer-to-peer architectures, but these are also problematic. Each player uses a client with an installed game application that handles an individual user's inputs, actions, and events, while also performing simulations that are necessary to enable game play. Peer-to-peer networking configurations for a game architecture are limited by the network bandwidth of individual clients, which are insufficient to handle large-scale distributed games (i.e., MMOG). Additionally, the number of data communication paths between nodes or elements (e.g., servers, clients, game servers, local servers, physics engines, and the like) is significantly larger thus increasing the aggregate amount of network traffic.

Further, in both client-server and peer-to-peer topologies, clients and servers alike are often mapped to particular “grids” in a game, preventing allocation of processing capabilities to areas of the game with increased activity (e.g., large numbers of players in a given area engaged in combat or other interactive activities). Thus, servers and clients used in current architectures are often inefficiently utilized because of specific assignments to map grids or coordinates.

If insufficient bandwidth or limited data communication paths are available, large numbers of users may generate substantial amounts of data traffic competing for a limited number of data communication paths and computational resources. Further, when an event in a game environment occurs, processing various functions among peers affected by an event or activity may be slowed due to insufficient bandwidth or data communication paths that are either limited in number or fail without alternate data communication paths or efficient re-routing.

Thus, what is needed is a solution for data communication and management in without the limitations of conventional implementations.

### BRIEF DESCRIPTION OF THE DRAWINGS

Various embodiments are disclosed in the following detailed description and the accompanying drawings:

FIG. 1A illustrates an exemplary hybrid peer-to-peer data communication and management system, in accordance with an embodiment;

FIG. 1B illustrates an alternative view of an exemplary hybrid peer-to-peer data communication and management system, in accordance with an embodiment;

FIG. 2A illustrates an exemplary nucleus server, in accordance with an embodiment;

FIG. 2B illustrates an exemplary local server, in accordance with an embodiment;

FIG. 2C illustrates an exemplary nucleus client, in accordance with an embodiment;

FIG. 3 illustrates a layered configuration of an exemplary hybrid peer-to-peer data communication and management system, in accordance with an embodiment;

FIG. 4 illustrates an exemplary map of a game environment, in accordance with an embodiment;

FIG. 5 illustrates an exemplary nodal configuration of a hybrid peer-to-peer data communication and management system, in accordance with an embodiment;

FIG. 6 illustrates an exemplary process for data communication and management, in accordance with an embodiment;

FIG. 7 illustrates an exemplary process for creating an alternate data communication path, in accordance with an embodiment; and

FIG. 8 is a block diagram illustrating an exemplary computer system suitable for hybrid peer-to-peer data communication and management, in accordance with an embodiment.

### DETAILED DESCRIPTION

Various embodiments may be implemented in numerous ways, including as a system, a process, an apparatus, or as computer program instructions included on a computer readable medium such as a computer readable storage medium or a computer network wherein program instructions are sent over optical or electronic communication links. In general, the steps of disclosed processes may be performed in an arbitrary order, unless otherwise provided in the claims.

A detailed description of one or more examples is provided below along with accompanying figures. The detailed description is provided in connection with such examples, but is not limited to any particular embodiment. The scope is limited only by the claims and numerous alternatives, modifications, and equivalents are encompassed. Numerous specific details are set forth in the following description in order to provide a thorough understanding. These details are provided for the purpose of example and the described embodiments may be implemented according to the claims without some or all of these specific details. For the purpose of clarity, technical material that is known in the technical fields related to the embodiments has not been described in detail to avoid unnecessarily obscuring the description.

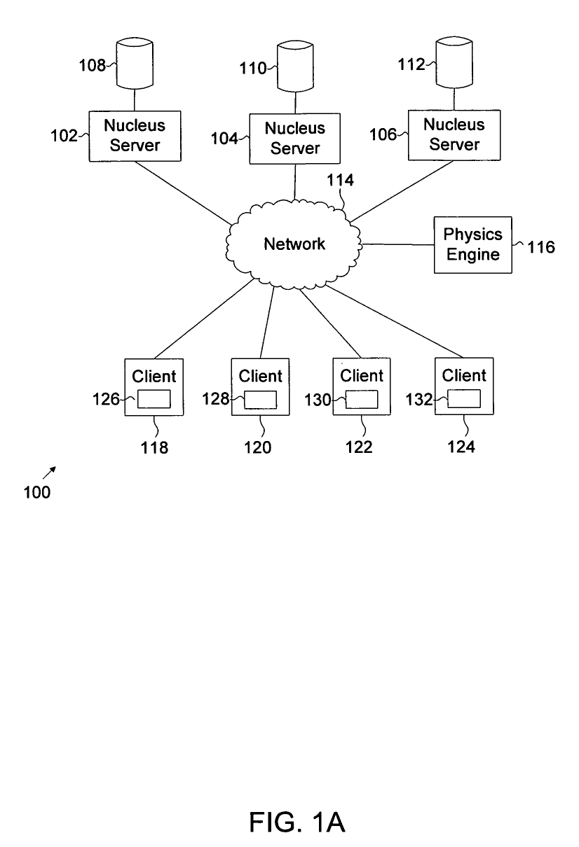

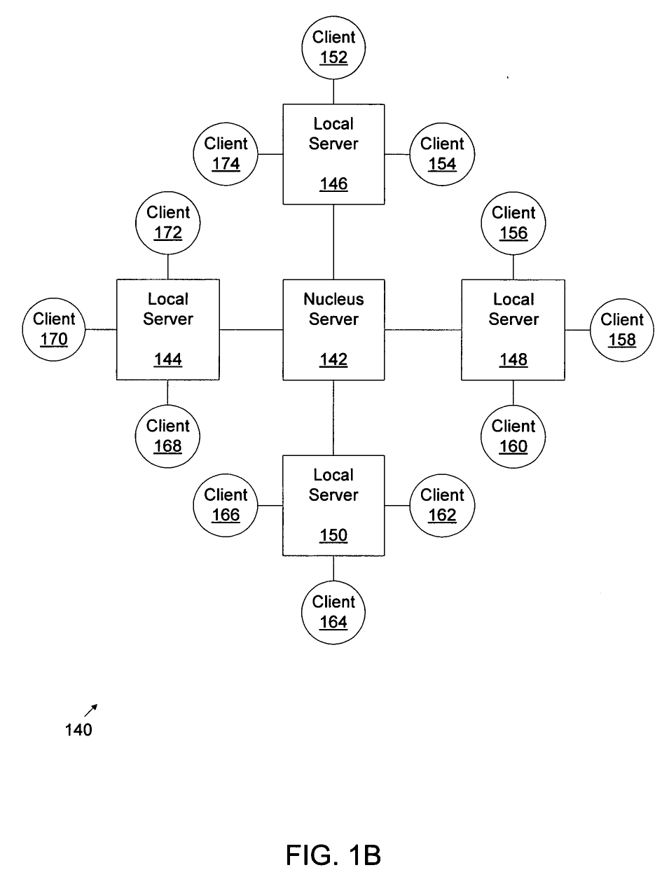

FIG. 1A illustrates an exemplary hybrid peer-to-peer data communication and management system, in accordance with an embodiment. Here, system 100 includes nucleus servers 102-106, databases 108-112, network 114, physics engine 116, clients 118-124, each of which includes one of nucleus clients 126-132. In some embodiments, nucleus servers 102-106 may be implemented as servers (i.e., processors or computers that may be used as a central communication or processing facility) that process various functions using a hybrid peer-to-peer data communication and management architecture, such as that shown in system 100. System 100 and the various elements shown may be implemented as hardware, software, circuitry, or a combination. In some embodiments, system 100 and the elements shown may be implemented as software that is developed using programming and formatting languages such as C++, .Net, Java, Oracle, SQL, MySQL, DB2, and others. System 100 is not limited to the languages listed above and may be implemented using some, all, or none of the languages described, including unstructured (e.g., COBOL, FORTRAN, Basic, DOS, machine assembly, and the like) and structured (i.e., object oriented, 3GL and 4GL languages, and the like). Examples of functions that may be performed by nucleus servers 102-106 include state management, database management, game environment management, data communication with peers (i.e., other nucleus servers) or clients 118-124. Each of nucleus servers 102-106 may be implemented to perform simulations of a game environment (e.g., a MMOG battlefield), but other functions may be performed other than those described above.

Databases 108-112 may be used to store data related to a game state, game environment, or other functions performed by nucleus servers 102-106. In some examples, each of nucleus servers 102-106 may use an internal or external database management system (DBMS) or application that manages one or more databases. Although each of nucleus servers 102-106 are coupled to databases 108-112, more databases may be implemented with each of nucleus servers 102-106 and are not limited to the configuration shown.

In some embodiments, physics engine 116 may be used to perform various physics processing functions to use variables related to activities in a game environment to predict actions and outcomes as they might occur under actual, physical environmental conditions. Physics processing functions may include position, motion simulations (e.g., fluid simulation), collision detection, three-dimensional (3D) variable or parameter determination, and other computation, calculation, or processing functions related to predicting the effects of various activities in a game environment based as opposed to actual physical occurrences. Using state data, simulations and physics functions (i.e., as performed by physics engines) enable the generation of an environment where players may interact with the environment and each other. State data may include data or information associated with state, events, or activities that occur in a game environment. In some embodiments, state data describes the current state of a game, events describes transitions or other occurrences that may affect the state of a game, and activities or actions are performed by users during game play that may cause a change in state or a transition to occur that affects the game state. Also, as described herein, “game,” “virtual,” or “simulated” may be used interchangeably. Physics engine 116, like nucleus servers 102-106, clients 118-124, and nucleus clients 126-132, may be implemented using an external server, an assigned server, or as logic installed using software, hardware, or a combination of both.

In some embodiments, physics engine 116 may be used to determine the effect of wind on a bullet that is fired from a weapon of an avatar, predict weather effects on game objects, or other actions that may occur in a game environment. Game simulations (i.e., simulations) are performed by one or more of nucleus servers 102-106 using state data and inputs (e.g., location of an activity, the type of activity, distance of a player's avatar or other object to an activity, and others) from physics engine 116 to generate and render a game environment on clients 118-124 by using nucleus clients 126-132. Further, game environment simulations may also be performed by clients 118-124 in addition to or as a replacement for nucleus servers 102-106 in a hybrid peer-to-peer environment.

As an example, clients 118-124 may use input from physics engine 116 and perform distributed processing of simulations, reducing processing requirements of nucleus servers 102-106. Further, by dynamically allocating nucleus servers 102-106 and nucleus clients 126-132 to perform simulations and processing to support a game environment based on a virtual location or proximity to an activity, peers (e.g., nucleus servers 102-106, nucleus clients 126-132) may be used in various configurations to address different processing requirements to enable the MMOG environment. Thus, system 100 is neither restricted in processing capabilities nor limited in data communication bandwidth.

In some embodiments, clients 118-124 may be implemented as standalone or networked computers, applications, or hardware/software combinations that are part of a distributed network (e.g., game environment) where players (i.e., users) at each client are able to interact and play within the virtual game environment using characters, avatars, virtual personae, and the like. Clients 118-124 may be implemented as a software application on a computer, hardware, circuitry, or as a combination. In some embodiments, nucleus client 126-132 may be implemented internally to clients 118-124 or as external applications in data communication with clients 118-124. In other embodiments, clients 118-124 and nucleus clients 126-132 may be implemented differently than as described above. As an example, during play, system 100 and the location of various functions (e.g., nucleus servers 102-106, clients 118-124, and nucleus 126-132) may automatically reconfigure to optimize use of existing resources to meet processing demands without requiring a fixed architecture or implementation that assign clients 118-124 to fixed servers over static communication paths.

FIG. 1B illustrates an alternative view of an exemplary hybrid peer-to-peer data communication and management system, in accordance with an embodiment. Here, system 140 includes nucleus server 142, local (game) servers 144-150, and clients 152-174, each of which may have a nucleus client (FIG. 1A) installed. In some embodiments, a nucleus client may be implemented as an application on one or more of clients 152-174 that is configured to exchange data with nucleus server 142 in order to perform processing functions related to game state, game environment, and simulations related to an MMOG. Local servers 144-150 may be implemented as servers to manage security, authentication, data communication, network configuration, network administration, billing, activity logging, escalation, environment validation, relationship, startup, static object, dynamic object, lock/thread/memory accesses, user accounts, and other functions. Other functions may be performed by local servers 144-150 implemented as local game servers that provide processing capabilities to support simulation of game environments. In other embodiments, other processing functions may be performed and are not limited to those described above. Game servers may be processing functions implemented locally or otherwise. In some embodiments, game servers may reside on a client. In other embodiments, game servers may be implemented independent of a client. Likewise, other processes, functions, or processing functions (e.g., local server, game server, nucleus server, and others) may be implemented with or external to a computing platform (e.g., client, server, application, and the like).

Further, system 140 may be implemented using a network (e.g., Internet, Ethernet/LAN, and the like) to enable data communication among more or fewer clients, local servers, and nucleus servers than those shown. In some embodiments, local servers may be dynamically allocated depending upon game activity and proximity of clients 144-150 to each other in the game space.

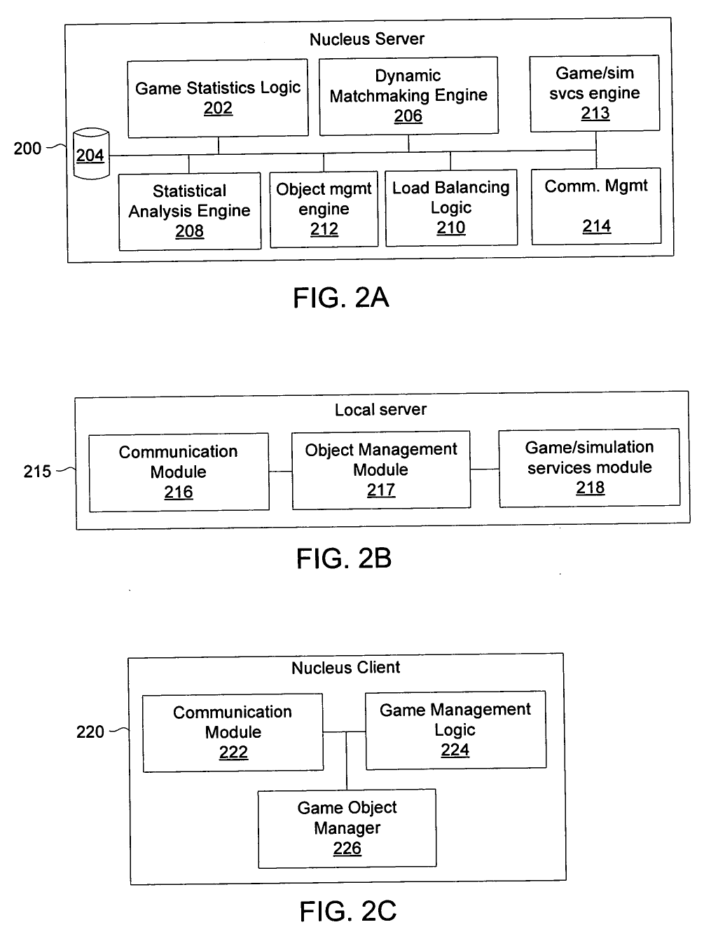

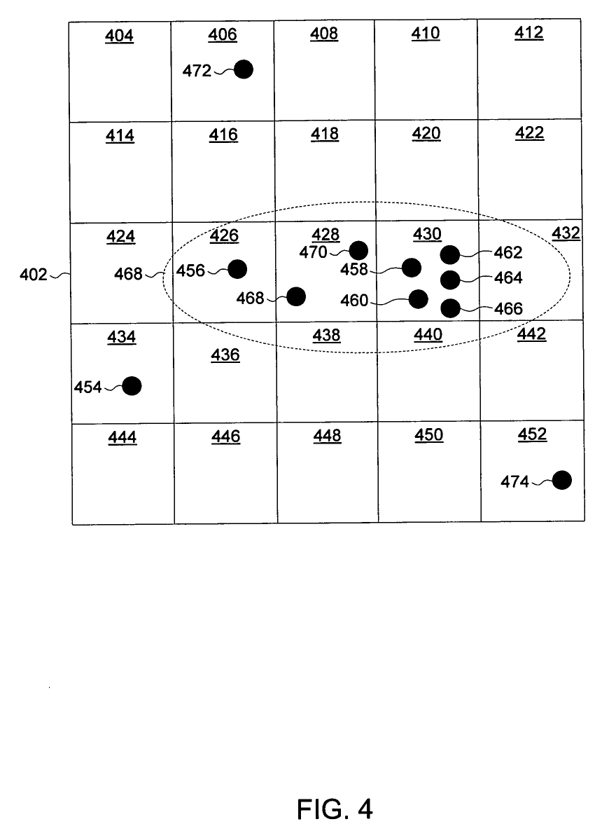

FIG. 2A illustrates an exemplary nucleus server, in accordance with an embodiment. Here, nucleus server 200 includes game statistics logic 202, database 204, dynamic matchmaking engine 206, statistical analysis engine 208, load balancing logic 210, object management engine 212, game/simulation services engine 213, and communication management module 214. Each of game statistics logic 202, database 204, dynamic matchmaking engine 206, statistical analysis engine 208, and load balancing logic 210 may be implemented as hardware, software, circuitry, or a combination thereof. In some embodiments, game statistics logic 202 manages data communication of statistical information from a game state or state data associated with a game environment. Statistics and other data may be stored in and retrieved from database 204 by various logic modules in nucleus server 200. In some embodiments, database 204 may be implemented using an internal or external database. Database 204 may also be implemented using multiple databases, which are managed by a DBMS (not shown). Statistical analysis engine 208 retrieves statistical data from database 204, which may be used to perform statistical analysis and functions (e.g., regressions and the like) to determine statistical outliers or anomalies that may be used by nucleus server 200 to manage data communication in a game environment. Statistical analysis engine 208 may also be used to anticipate individual client activity, individual server activity, communication bandwidth requirements, and trends based on game and historical Internet activity. Statistical analysis engine 208 may also be used to help determine when and what type of operational maintenance is performed on the environment to provide a “self-healing” environment. Dynamic matchmaking engine 206, in some embodiments, may be used to dynamically allocate elements (e.g., nucleus servers, local servers, nucleus clients, and the like) to perform processing of events associated with activities occurring in a game environment, which is described, as an example, in greater detail below in connection with FIG. 4. Dynamic matchmaking engine 206 may also perform matching-making operations that also include grouping one, some or all clients and servers (i.e., functions) to optimize one, some, or all environmental resources. Here, environmental resources may include resources assigned to the game environment, freely available on the Internet, or others available in a user's local environment. In other words, game space position and current activities are also considered with available computer resources and contemporary capabilities of the available computer resources.

Referring back to FIG. 2A, dynamic matchmaking engine 206 determines the allocation of elements to process functions associated with events and activities occurring in a game environment. In some embodiments, a distance to the location of an activity or event may be determined using position coordinates (i.e., X, Y, Z) and vector analysis to determine motion, position, and other effects. In other embodiments, location of activities or events may be grouped in an area of a game environment, resulting in a large number of physics calculations (i.e., by physics engines) and simulations, thus requiring elements to be allocated to handle the activities and events. In still other embodiments, nucleus server 200 may determine that clients in proximity to virtual activities or events occurring in a game environment may be handled by performing simulations at clients near an activity, requesting physics engines (not shown) to perform other functions (as described above) that provide input (e.g., weather or motion simulations, and others) to clients or servers. When configured in a hybrid peer-to-peer network, some simulations may be performed by nucleus server 200 while other simulations are performed by nucleus clients (not shown) and a hybrid client-server/peer-to-peer processing configuration allows elements in a network configuration to efficiently process the various functions associated with maintaining a MMOG game state and environment.

In some embodiments, load balancing logic 210 may be implemented to balance data traffic and communication loads among various elements of a hybrid peer-to-peer network. Load balancing may use a predictive model that is configured to anticipate game activity based on data and statistics from previous game histories and to distribute computing activities across both nucleus servers 102-106 (FIG. 1A) and local servers 144-150 (FIG. 1B). As an example, nucleus server 200 may be in data communication with one or more clients having nucleus clients installed on each one (not shown). When an event (e.g., a turn in game play, a player or set of players achieve a pre-determined level of game play, a game is initiated, a game ends, and the like) occurs, load balancing logic 210 may be configured to poll, query, or request state data from elements in a hybrid peer-to-peer network that supports the game environment. State information may be minimally propagated upward to a central storage location (e.g., database 204) throughout play during times of low bandwidth use. State information may also be minimally propagated upward to a central storage location (e.g., database 204) during major state changes (e.g., player dies). Using state data and data associated with the event and related activities, load balancing logic 200 directs data traffic (e.g., packets, frames, segments, and the like) to elements in various patterns (e.g., “round-robin,” sequentially, randomly, and others). Guided by instructions from dynamic matchmaking logic 206, load balancing logic 210 gathers input from nucleus clients in the game environment. Load balancing logic 210 helps to ensure that data traffic does not become congested and that each nucleus client or physics engine provides input for a given event or activity occurring in the game environment, which prevents data transmission latencies and increases the speed of game play, which is significant factor in real-time game simulations. Together, game statistics logic 202, database 204, dynamic matchmaking engine 206, statistical analysis engine 208, and load balancing logic 210 enable nucleus server 200 to manage data communication in various environments (e.g., MMOG).

Also shown are object management engine 212, game simulation services engine 213, and communication management module 214. In some embodiments, object management engine 212 may be used to minimize network traffic by identifying objects using an ID number. Instead of transmitting a complete or changed object description each time an object is referenced, attributes associated with a changed object or a group of changed objects may be transmitted. For example, if a weapon is fired in a game environment, a message is sent that identifies the weapon by an ID number or a code may be sent indicating that the weapon was discharged and the type of ammunition that was used. In some embodiments, a previous message is sent identifying the direction in which the weapon was discharged. As another example, when an object is changed or moved, the object is may be transmitted. In other words, if an object is within a group (e.g., a person is holding a weapon, where the person and the weapon are represented by individual objects), a group change information object may be transmitted. Each server and client may be configured to propagate the change information to each object in the group. The use of object references and grouping enables a decrease in network bandwidth requirements and avoids conventional bandwidth problems due to large amounts of traffic that are transmitted when a large number of complete objects are transmitted. In other embodiments, object management engine 212 may be implemented as a module apart from nucleus server 200 or may be implemented differently than described above.

Here, game/simulation services engine 213 is implemented to provide support for processes and functions that are used to create, manage, or modify a game environment or simulation in the game environment. Communication management module 214 provides data communication capabilities between nucleus server 200 and other elements (e.g., local server, nucleus client, clients, other nucleus servers, and the like). In other embodiments, game simulation services engine 213 and communication management module 214 may be implemented differently and is not limited to the embodiments described above. Further, nucleus server 200 may be implemented differently apart from the embodiments described above.

FIG. 2B illustrates an exemplary local server, in accordance with an embodiment. Here, local server 215 includes communication module 216, object management module 217, and game/simulation services module 218. In some embodiments, communication module 216 provides data communication capabilities between local server 215 and other elements (e.g., nucleus servers, nucleus clients, servers, clients, physics engines, and the like). Object management module 217 provides and manages game objects and associated information (e.g., object details including size, velocity, direction, type of weapon, damage, health, and others). Object management module 217 receives requests for various operations involving objects. If an object is not present on local server 215, the request is sent back to nucleus server 200 (FIG. 2A), which performs the requested operation and passes the resulting information back to local server 215. Subsequently, local server 215 passes information to nucleus client 220, providing local object information caching in close proximity to active clients using the information and retaining master object copies residing on nucleus server 200 that may be accessed upon request. Additionally, game/simulation services module 218 provides support for processes and functions that are used to create, manage, or modify a game environment or simulation in the game environment. Local server 215 may be implemented as a program (i.e., application), library, or dynamic linked library (“DLL”) included with each client. Local server 215 operates in the same environment or computer as a nucleus client. In some embodiments, games played on mobile devices such as mobile phones (i.e., cell phones) may be implemented apart from a client if power and memory are limited. For mobile devices, local server 215 may be implemented on a computer in a network virtual space (i.e., computing or processing capabilities (i.e., multiple servers) implemented on a single computer). In some embodiments, a developer can integrate computer program code into a virtual environment or network by adding, modifying, or deleting a computer program implemented with local server 215. By implementing a client apart from local server 215, if a computer program (i.e., application) fails, the failure may not cause local server 215 to fail. This maintains operation of local server 215, which maintains local state information and minimizes errors caused by program or communication latencies and failures. As an example, local server 215 and a client may be in data communication. The client may include a computer program, application, or software code (“code”) for a game, such as those developed by game developers. The client communicates with other nodes or elements (e.g., servers, clients, nucleus servers, nucleus clients, local servers, physics engines, and the like) through local server 215, which may be included on a single computer system. Further, local server 215 and a client may be in close “virtual” proximity to each other. In other words, if local server 215 and a client are supporting simulations that are in close proximity in a virtual game space, these components may be considered to be in close virtual proximity. In some embodiments, local server 215 may be in data communication with one or more clients, tracking how and where to communicate with other nodes to support a game or virtual environment. Still further, local server 215 may also be configured to track primary and secondary (i.e., alternate) data communication paths among various nodes. In other embodiments, local server 215 and the above-described components may be implemented differently.

FIG. 2C illustrates an exemplary nucleus client, in accordance with an embodiment. Here, nucleus client 220 includes communication module 222, game management logic 224, and game object manager 226. In some embodiments, nucleus client 220 may be implemented on a client. Nucleus client 220 may be used to provide data communication and management functions on clients that are included in a hybrid peer-to-peer data communication and management system. Nucleus client 220 may be implemented as hardware, software, circuitry, or a combination thereof. Communication module 222 enables bi-directional data communication between nucleus client 220, nucleus server 200 (FIG. 2A), game and local servers, clients, and other elements that may be implemented in a hybrid peer-to-peer network. Communication module 222 may be implemented in one, some, or all nucleus clients 220. In some embodiments, nucleus client 220 may be implemented as a dynamic linked library (DLL) or an object library that a third party's game code links with or calls in order to communicate with another client and/or server. Communication module 222 provides secure communication services for nucleus client 220.

Here, game management logic 224 may be implemented on a client (not shown) to manage data communication between nucleus client 220 and nucleus server 200. As a player interacts with a game, state data, and data associated with activities that occur affecting players may be identified by game management logic 224 and communicated to nucleus server 200 using communication module 222. Data traffic may be routed through ports (not shown) on a client that are identified and chosen by game management logic 224. In some embodiments, game management logic 224 may also determine how a given client interacts with other clients in a game environment. Game management logic 224 may also help dynamic matchmaking engine 206 in determining how elements (e.g., clients, nucleus clients, nucleus servers, and the like) are dynamically allocated to process events and activities that occur in locations that are in close virtual proximity to the position specified by nucleus client 220. Nucleus client 220 may be varied in both function and structure and is not limited to the embodiments described above.

In some embodiments, game object manager 226 may also be included. Game object manager 226 enables a game to get and manage game objects and relevant information and details. When game object manager 226 is called, it communicates with a local server to perform a requested operation. If an object is not present on the local server, the local server may forward the request back to a nucleus server 200 (FIG. 2A), which performs the requested operation and passes the resulting information back to the local server. Subsequently, the local server passes the resulting information to nucleus client 220, providing local object information caching in close proximity to active clients using the information, keeping master object copies that reside on nucleus server 200 that may be accessed upon request.

In some embodiments, game object manager 226 may be used to change objects within a virtual game space. For example, a game may be played with a user driving a Ford™ Focus. Game object manager 226 may be used to change the Ford™ Focus to a VW™ Rabbit, which may be performed for advertising or marketing purposes. Game object manager 226 provides customization abilities for a virtual game space and objects contained within it. In some embodiments, changes to objects within a virtual game space may be performed externally or internally using game object manager 226, without manually changing source code or releasing a program update. Nucleus client 220 and the above-described components may be varied and are not limited to the descriptions provided above.

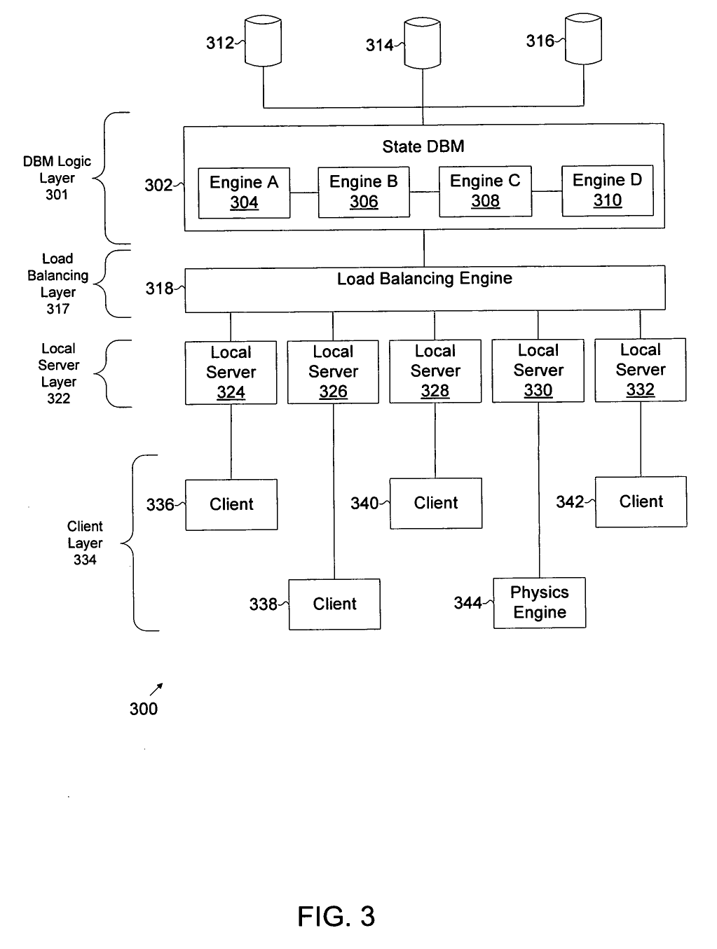

FIG. 3 illustrates a layered configuration of an exemplary hybrid peer-to-peer data communication and management system, in accordance with an embodiment. In some embodiments, a gaming application or system may be described using a layered configuration. Here, system 300 may be classified into several layers including database management (“DBM”) logic layer 301, which includes state database management module 302, engines 304-310, and databases 312-316. Also included are a load balancing layer 317 having load balancing engine 318. Local server layer 322 includes local servers 324-332. Client layer 334 includes clients 336-342 and physics engine 344, each of which may function as described above. The above-described layers may include different quantities and types of components and may be varied in other implementations. In some embodiments, local server layer 322 may be configured to perform ‘distributed’ game functions “close” (i.e., “close” refers to proximity based on data communication paths, virtual distance, geographical distance, or other parameters) to clients 336-342, which are managed by load balancing engine 318. In some embodiments, load balancing may include the management of non-local or remote computing capacity and the selection or management of communication data paths to access the non-local or remote computing capacity. Load balancing may also involve dynamic use of different communication protocols and data communication paths depending on current loads and request types.

Here, data traffic may be communicated between the various layers to support game play and a game environment. As an example, data traffic from one or more clients 336-342 are passed, along with data traffic from physics engine 344, to load balancing engine 318. In some embodiments, data traffic may be queried or requested from clients 336-342 using a variety of techniques, including “round-robin,” sequential, random, parallel, and others. Upon receiving data traffic from clients 336-342 and physics engine 344 (in some embodiments, multiple physics engines 344 may be implemented), data is then passed from load balancing engine 318 to state DBM module 302. One or more of engines 304-310 may be used to process the data traffic from load balancing engine 318. Each of engines 304-310 may be used to perform a different processing function, the results of which may be stored in databases 312-316. As an example, each of engines 304-310 may be used to process simulations affecting character/avatar interplay, terrain, motion, combat, speech, video, and other aspects of a game environment. Physics engine 344 provides data that predicts how activities or actions in a game environment would occur under actual, physical conditions, which may be used to provide a realistic game environment. Input from physics engine 344 may be used in simulations of various aspects of a game environment that affects a given character or avatar allocated to one of clients 336-342. Although system 300 may be implemented as described above, system 300 may be implemented differently and is not limited to the embodiments described above.

FIG. 4 illustrates an exemplary map of a game environment, in accordance with an embodiment. Here, map 402 may be used to illustrate a game environment, which may be apportioned into grids 404-452. Players 454-472 are positioned in grids 406, 426-430, 434, and 452. In some embodiments, maps may be two or three-dimensional representations. If “time” is considered as an added dimension, some maps may be four-dimensional. Group 468 includes players 456-470. In some embodiments, servers may be allocated to perform processing functions for simulations, physics calculations, state management, and others. In other words, nucleus servers and nucleus clients may be clustered to process simulations associated with areas of activity. As an example, group 468 may be identified as having a large amount of activity using statistical analyses (i.e., by statistical analysis engine 208 (FIG. 2A)) or other techniques to dynamically allocate elements to process functions (e.g., simulations) for a game environment. In some examples, nucleus servers and nucleus clients may be dynamically allocated to support concentrated activity, as indicated by group 468. By dynamically allocating elements to support areas requiring simulation processing, bandwidth and processing capabilities of a peer-to-peer network may be efficiently used. Nucleus servers (not shown) may be directed from areas of inactivity (e.g., grids 404, 410-422, 436-450) and clustered to process activity and events affecting players in group 468. In some embodiments, elements may be clustered to combine computing resources to process functions for state management, a game environment, or the like. By dynamically allocating elements (i.e., computing resources) away from inactive grids to handle activity, game play can be improved in both bandwidth requirements, speed, player interaction, and scalability (i.e., allowing large numbers of players in a MMOG without requiring large numbers of game servers and physics engines to support a large number of clients). As an example, some processes or functions to support a game environment may be assigned to some computing resources, but other computing resources may be “pooled,” and assigned (i.e., used) when requested or called. In some embodiments, computing resources that are assigned to perform a process or function may be reclaimed for other processes by moving the current computing activities to another computing resource, which enables computing resources to be ubiquitously assigned without permanent assignments to particular locations. In other embodiments, elements may be dynamically allocated differently and are not limited to the descriptions provided above.

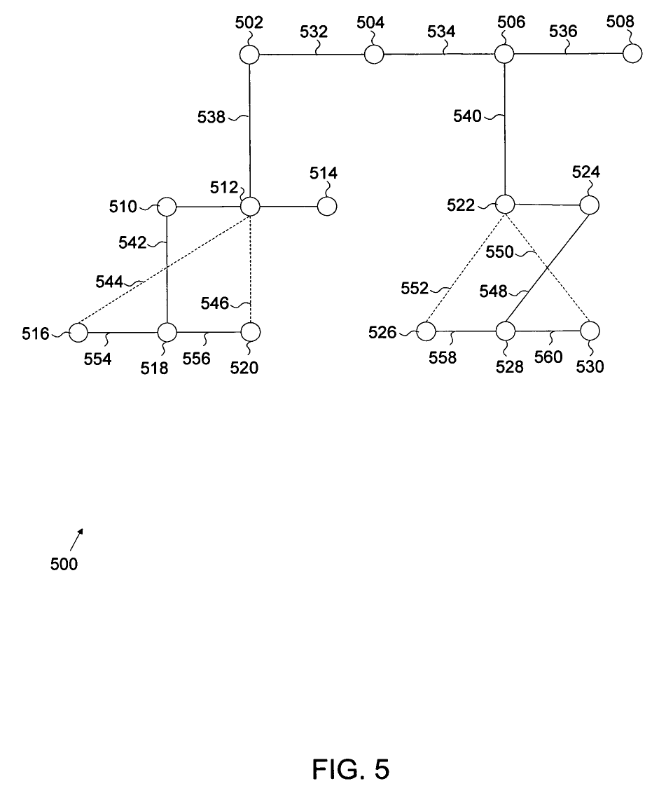

FIG. 5 illustrates an exemplary nodal configuration of a hybrid peer-to-peer data communication and management system, in accordance with an embodiment. Here, nodal configuration 500 represents three (3) layers of nodal elements. Nodes 502-508 represent a top level of nodes in a nodal hierarchy. Nodes 510-514, 522, and 524 represent an intermediate level of nodes and nodes 516-520 and 526-530 represent a low level of nodes. The top layer may be used as an abstract representation of a nucleus server layer, a load balancing logic layer, and a client layer, including nucleus clients implemented on clients. Data communication paths 532-560 provide paths for routing data traffic between nodes 502-530. In some embodiments, data communication paths may be established as “ghost” paths. “Ghost” paths or connections may be alternate data communication paths used to replace a data communication path that fails. As an example, a “ghost” connection may be implemented if, along a primary data communication path, a “heart beat” or diagnostic signal fails. In some embodiments, a “heart beat” message (not shown) may be a message transmitted between two nodes for a diagnostic purpose, such as determining whether a particular node (i.e., endpoint) is available. When a node receives a “heart beat” message, a response message is sent back to signal a “Yes.” In some embodiments, status and performance information may also be sent with the response message. Further, a “heart beat” message conveys information that indicates the last time or instance when a response message (i.e., signaling availability) was received from an adjacent node. If an indication (i.e., message) is not received from a node within a proscribed interval, a “heart beat” message is generated. “Heart beat” messages are used to indicate the availability or status of a node, in light of time-out parameters of data communication paths. When a data communication path “times-out,” software and hardware components in the path are closed and the path may be reallocated to another activity. Opening and closing a path is an expensive operation, but the use of a “heart beat” message ensures a given data communication path is maintained without incurring additional or redundant negotiation between nodes in a data communication path.

In some embodiments, if a “heart beat” message fails (i.e., the packets do not reach the designated destination endpoint), “ghost” connections (e.g., 544, 546, 552, 550) are established, which provides a failover or alternate data communication path. In some embodiments, ghost connections may be identified by configuration data and information that are stored in nodes (i.e., nodes 510-530) serviced by a data communication path. Configuration data and information may include information that identifies other nodes disposed a set number of hops away. For example, node 520 receives data from node 502 along data communication paths 538 and 542. If data communication path 542 fails (i.e., a “heart beat” message is lost or not detected), node 520 has configuration data and information for two hops up the nodal configuration. In other words, configuration data and information “ghost” connection 546 is stored with node 520 and when data communication path 542 fails, “ghost” connection 546 is established. An arbitrary number of hops may be used as a parameter for determining how much nodal information is stored by each node. A data communication path is established based on communication performance and reliability over a given period of use. Communication performance is determined by how long it takes to send a message and receive a response. Communication performance of a data communication path may also be selected based on determining a path with the lowest transmission time for sending a message and receiving a response. Hops (i.e., path lengths between nodes) may be used as an indicator of communication performance and circuit stability. In some embodiments, larger numbers of hops indicates longer response times and greater unreliability. In other words, communication performance and data communication path reliability are used to determine routes for sending and receiving messages. Examples of information that may be used include the number of hops, ports, latency, bandwidth, and other parameters. In other examples, nodal configurations may be implemented differently and are not limited to the embodiments described above.

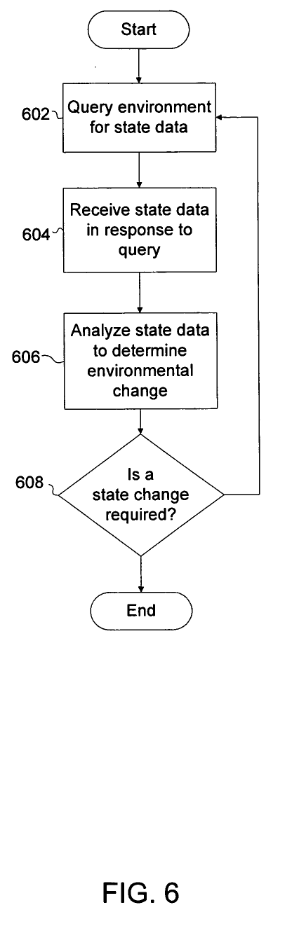

FIG. 6 illustrates an exemplary process for data communication and management, in accordance with an embodiment. In some embodiments, data communication and management may be implemented to manage and update state data. State data includes data that describes a state, from its inception to the present moment, of a game environment, the game environment being a virtual construct used by players to interact during a MMOG or other game. Transition data indicates a change or event that occurs in the state due to environmental, player, or other types of actions, which may be analogous to activities as described above. Here, a process for data communication and management may be executed by a supervisory server or process (e.g., nucleus server) begins by querying an environment (i.e., game environment) for state data (e.g., state, transitions, actions/activities, events) (602). State data is received in response to the query (604). After receiving state data, analysis is performed to determine whether a change to the game environment is to occur (i.e., transition or event) (606). After analyzing the state data, a test is performed to determine whether a state change is being requested (i.e., are modifications to the game environment required) (608). If an a state change is required, then an additional query is performed and a state change is performed, repeating the process until an equilibrium state (i.e., the game environment does not require additional changes) is reached. If no changes are required, then the process ends. In other embodiments, the above process may be modified and is not limited to the above description.

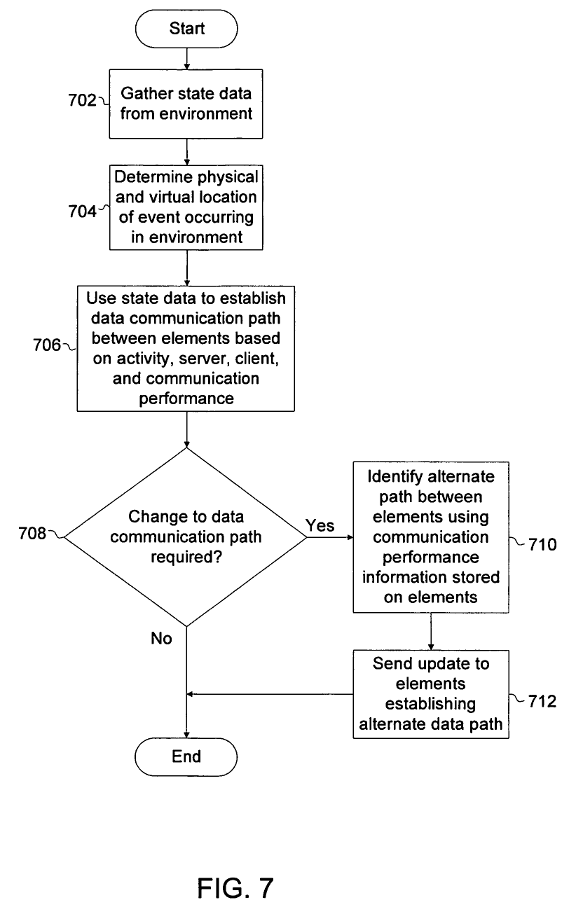

FIG. 7 illustrates an exemplary process for creating an alternate data communication path, in accordance with an embodiment. Here, a process for managing data communication and data communication paths, as described above in connection with FIG. 5, is described. State data is gathered from an environment (e.g., game, network, processing environments may be used interchangeably) (702). Using the gathered state data, a location of an event (i.e., transition) occurring in the environment may be determined (704). An event location may be a virtual or physical location. After determining a location for an event or transition, state data may be used to establish a data communication path between system elements (e.g., nucleus server, nucleus client, local server, game server, client, and others) based on actions or activities, server, client, and communication performance characteristics of the environment (e.g., player interactions) (706). In some embodiments, when a new node is created or added to an environment, the primary and secondary data communication paths for the node are defined and established with other nodes. These primary and secondary data communication paths are reserved and maintained in an “open” condition while the node is included (i.e., attached) to the environment. Data connectivity with a node may be determined based on virtual distance in an environment, but may also be determined based on which computing resources the node communicates with frequently. In some embodiments, high use (i.e., traffic) data communication paths are direct connections between nodes and low use data communication paths may transit through other or alternate nodes. A system (e.g., system 100 (FIG. 1A), system 140 (FIG. 1B)) monitors system operation and determines the optimal number of nodes for a given data communication path (i.e., primary or secondary) at a given time. Alternate data communication paths may be implemented when a primary data communication path fails during a request, a “heart beat” response message is not received within a predetermined interval, an alternate data communication path becomes more “attractive” in terms of data communication performance, or a client or server receives a supervisory message from a nucleus server (i.e., supervisory server, nucleus supervisory server) that directs the client or server to change a data communication path and any corresponding security codes. When changes are made, affected nodes are also notified of the change, which may be transparent to game play, users, and the game (i.e., simulated) environment When a data communication path is established, a determination is made as to whether a change in the data communication path is required (708). In some examples, a detected change may be the failure of a “heart beat” message, a change or failure of a node (e.g., router, switch, central office, component of a network (e.g., Internet, Ethernet/LAN, MAN, WAN, and others), or other network condition that indicates the originally identified data communication path is no longer available. If a change is required, then an alternate data communication path between elements is identified (710). As an example, communication performance (e.g., number of hops, available or unavailable network components (e.g., switches, routers, backbone, and the like), latency times, network conditions, and others) information stored and retrieved by elements when a change is identified may be used to select and configure a “ghost” connection, as described above in connection with FIG. 5. Referring back to FIG. 7, when an alternate data communication path has been identified, a state update is sent (i.e., pushed) to elements affected by the routing change, providing data and information associated with identifying and establishing an alternate data communication path (i.e., “ghost” connection) (712). Subsequently, or if no change to a data communication path is detected, the process ends. Data communication path changes are event drive. Two types of events may cause data communication path changes: physical and virtual. A physical event may occur if a data communication path (i.e., circuit) is lost, a server shuts down or otherwise becomes unavailable, or poor communication performance characteristics are present (e.g., high latency, low bandwidth). A virtual event may occur if a user (i.e., client) moves to a different location in a game space, which may require regrouping of clients. Physical and virtual events may also include other conditions and characteristics in addition to those described above. In some embodiments, this process may be repeated randomly, periodically, frequently, continuously, or over other periodicities to ensure a data communication path is maintained. Other processes may be implemented that use network configuration techniques such as those described above.

As an example, flooding prevention may be implemented using data communication paths such as those described above. Data flooding may occur if the UDP communication protocol is used and application-generated acknowledgements are not received in a timely manner. Data flooding may also occur if an event triggers another event, which subsequently triggers more and more cascading events causing data to be constantly and continuously pushed between servers and clients. To prevent large amounts of state data from being forwarded to every client participating in a MMOG, flooding prevention may be implemented. In some embodiments, flooding prevention may be used to prevent processing and sending a complete set of state data updates to every client in an environment. Using a common time or system clock signal, an “event complete” signal may be sent that signals when an event has occurred and state data updates are initiated. In addition to using a common time clock to synchronize data states, data flooding logic may be implemented. Logic may provide for collecting events, discarding irrelevant events (i.e., events not affecting a given activity or action), and transmitting selected events to appropriate servers and clients, instead of all servers and clients in a given system. In some embodiments, a local server may act as a “gatekeeper” to execute the above logic, selecting particular events from irrelevant or undesired events and deciding which clients or servers are to receive the selected events. Data objects (i.e., used to update state data at each client) may be sent from a nucleus server to a nucleus client. The state data updates may also be sent to other nucleus clients without sending a complete copy of the data object by extrapolating the position of other nucleus clients relative to the initially-identified client. In other words, if a data object is sent from one nucleus client to another nucleus client and the object's position is extrapolated relative to other nucleus clients, an update may be sent to the other clients without sending a complete copy of the data object. This reduces the processing and data communication load on a nucleus server, reducing the amount of bandwidth required to send the data packets associated with the data objects. In order for a nucleus server to update nucleus clients, a common time or system clock is used for synchronization. The above processes may be modified and are not limited to the embodiments described above.

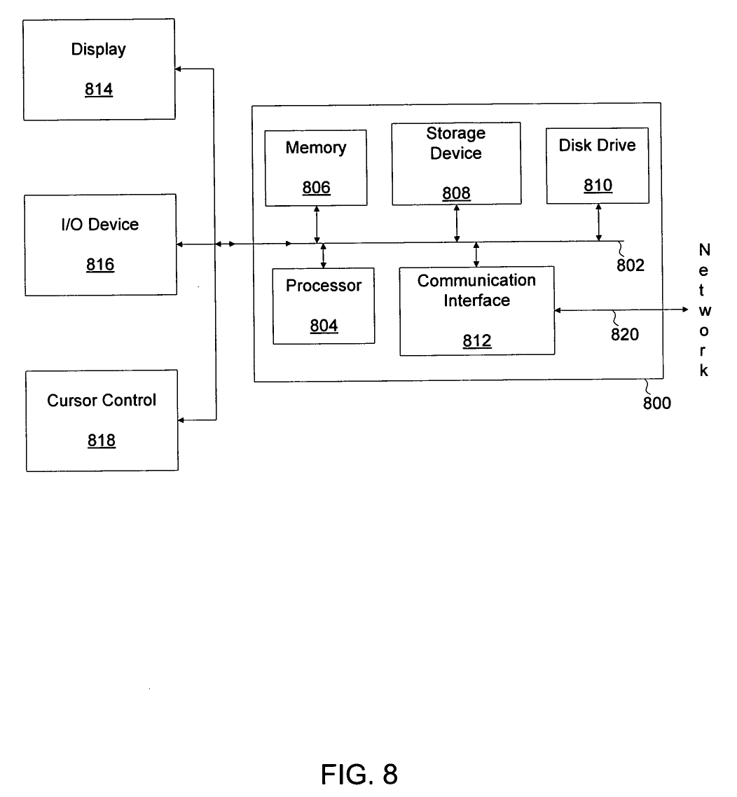

FIG. 8 is a block diagram illustrating an exemplary computer system suitable for hybrid peer-to-peer data communication and management, in accordance with an embodiment. In some embodiments, computer system 800 may be used to implement computer programs, applications, methods, or other software to perform the above-described techniques for fabricating storage systems such as those described above. Computer system 800 includes a bus 802 or other communication mechanism for communicating information, which interconnects subsystems and devices, such as processor 804, system memory 806 (e.g., RAM), storage device 808 (e.g., ROM), disk drive 810 (e.g., magnetic or optical), communication interface 812 (e.g., modem or Ethernet card), display 814 (e.g., CRT or LCD), input device 816 (e.g., keyboard), and cursor control 818 (e.g., mouse or trackball).

According to some embodiments of the invention, computer system 800 performs specific operations by processor 804 executing one or more sequences of one or more instructions stored in system memory 806. Such instructions may be read into system memory 806 from another computer readable medium, such as static storage device 808 or disk drive 810. In some embodiments, hard-wired circuitry may be used in place of or in combination with software instructions to implement the invention.

The term “computer readable medium” refers to any medium that participates in providing instructions to processor 804 for execution. Such a medium may take many forms, including but not limited to, non-volatile media, volatile media, and transmission media. Non-volatile media includes, for example, optical or magnetic disks, such as disk drive 810. Volatile media includes dynamic memory, such as system memory 806. Transmission media includes coaxial cables, copper wire, and fiber optics, including wires that comprise bus 802. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In some embodiments of the invention, execution of the sequences of instructions to practice the invention is performed by a single computer system 800. According to some embodiments of the invention, two or more computer systems 800 coupled by communication link 820 (e.g., LAN, PSTN, or wireless network) may perform the sequence of instructions to practice the invention in coordination with one another. Computer system 800 may transmit and receive messages, data, and instructions, including program, i.e., application code, through communication link 820 and communication interface 812. Received program code may be executed by processor 804 as it is received, and/or stored in disk drive 810, or other non-volatile storage for later execution.

Although the foregoing embodiments have been described in some detail for purposes of clarity of understanding, implementations of the above-described system and techniques is not limited to the details provided. There are many alternative implementations and the disclosed embodiments are illustrative and not restrictive.

What is claimed:

1. A method for state management, comprising:
querying a plurality of elements in an environment for state data, wherein the state data describes a state of the environment and an activity occurring in the environment;
receiving the state data from one or more of the plurality of elements in response to the querying;
analyzing the state data to determine an environmental change, wherein updated state data is generated describing the environmental change; and
using the updated state data to modify the environment by dynamically allocating the plurality of elements to process a simulation, the plurality of elements being dynamically allocated based on available processing capacity provided by the plurality of elements.

2. The method recited in claim 1, wherein the plurality of elements are dynamically allocated by adjusting the plurality of elements to provide one of the plurality of elements to process the simulation for the environmental change.

3. The method recited in claim 1, wherein the plurality of elements are dynamically allocated by clustering the plurality of elements based on a proximity to the activity.

4. The method recited in claim 3, wherein the proximity is a physical proximity.

5. The method recited in claim 3, wherein the proximity is a virtual proximity.

6. The method recited in claim 1, wherein the environment is a game environment.

7. The method recited in claim 1, wherein at least one of the plurality of elements is a client.

8. The method recited in claim 1, wherein at least one of the plurality of elements is a server.

9. The method recited in claim 1, wherein at least one of the plurality of elements is a game server.

10. The method recited in claim 1, wherein using the updated state data further includes mapping the environment based on dynamically allocating the plurality of elements.

11. The method recited in claim 1, wherein using the updated state data further includes dynamically allocating the plurality of elements to process a simulation associated with the activity and the environment.

12. The method recited in claim 1, wherein using the updated state data further includes performing a simulation at one or more of the plurality of elements.

13. The method recited in claim 1, wherein using the updated state data further comprises sending an update to one or more of the plurality of elements, the update being configured to minimize data transmission to the environment.

14. The method recited in claim 1, wherein using the updated state data further comprises sending an update to one or more of the plurality of elements, the update being configured to minimize data transmission.

15. The method recited in claim 1, wherein using the updated state data further comprises sending an update associated with the state to one or more of the plurality of elements, the update describing an event in the environment.

16. The method recited in claim 1, wherein the updated state data describes an event.

17. A method for data communication, comprising:
gathering state data from an environment, the state data being associated with a state of the environment and a plurality of elements;
determining a location of an event in the environment, the location being described by the state data;
using the state data to establish a data communication path in the environment, wherein the data communication path is determined based on evaluating the state data, the location, and the event;
detecting a change to the data communication path; and
updating the environment and the data communication path by dynamically creating an alternate data communication path between the plurality of elements based on the change, the alternate data communication path being configured to route data among the plurality of elements, wherein each of the plurality of elements disposed along the data communication path has information associated with the alternate data communication path.

18. The method recited in claim 17, wherein the event is a physical event.

19. The method recited in claim 17, wherein the event is a virtual event.

20. The method recited in claim 17, wherein the data communication path is established between one of the plurality of elements and another of the plurality of elements

21. The method recited in claim 17, wherein one of the plurality of elements is a client.

22. The method recited in claim 17, wherein one of the plurality of elements is a server.

23. The method recited in claim 17, wherein the data communication path is determined by analyzing the state data.

24. A system for state management, comprising:
a local server configured to query a plurality of elements in an environment for state data, wherein the state data describes a state of the environment and an activity occurring in the environment, to receive the state data from one or more of the plurality of elements in response to the querying, to analyze the state data to determine an environmental change, wherein updated state data is generated describing the environmental change, and to use the updated state data to modify the environment by dynamically allocating the plurality of elements to process a simulation, the plurality of elements being dynamically allocated based on available processing capacity provided by the plurality of elements; and
a client in data communication with the local server and a node, the client being used to interact with the environment, wherein the state data and the updated state data are exchanged between the client, the node, and the local server to manage the environment.

25. The system recited in claim 24, wherein the node is a server.

26. The system recited in claim 24, wherein the node is a local server.

27. The system recited in claim 24, wherein the node is another client.

28. A system for data communication, comprising:
a local server configured to gather state data from an environment, the state data being associated with a state of the environment and a plurality of elements, to determine a location of an event in the environment, the location being described by the state data, to use the state data to establish a data communication path in the environment, wherein the data communication path is determined based on evaluating the state data, the location, and the event, to detect a change to the data communication path, and to update the environment and the data communication path by dynamically creating an alternate data communication path between the plurality of elements based on the change, the alternate data communication path being configured to route data among the plurality of elements, wherein each of the plurality of elements disposed along the data communication path has information associated with the alternate data communication path; and
a client in data communication with the local server and a node, the client being used to interact with the environment, wherein the state data is exchanged between the client, the node, and the local server to manage the environment.

29. A system for managing a game environment, comprising:
a client configured to provide the game environment established using a game state;
a physics engine configured to perform a function that generates information associated with the game state;
a server having:
a database management system configured to manage one or more state machines, each of the one or more state machines being configured to determine a substate of the game state;
a load balancing engine configured to manage data communication between the server and the client and the physics engine, wherein the server, the client, and the physics engine are dynamically allocated based on activity generated in the game environment; and
a map associated with the game environment, wherein the map is used to allocate the client and the server to process a simulation in the game environment using the information associated with the game state, wherein the client and the server are allocated based on the activity.

30. A computer program product for state management, the computer program product being embodied in a computer readable medium and comprising computer instructions for:
querying a plurality of elements in an environment for state data, wherein the state data describes a state of the environment and an activity occurring in the environment;
receiving the state data from one or more of the plurality of elements in response to the querying;
analyzing the state data to determine an environmental change, wherein updated state data is generated describing the environmental change; and
using the updated state data to modify the environment by dynamically allocating the plurality of elements to process a simulation, the plurality of elements being dynamically allocated based on available processing capacity provided by the plurality of elements.

31. A computer program product for data communication, the computer program product being embodied in a computer readable medium and comprising computer instructions for:
gathering state data from an environment, the state data being associated with a state of the environment and a plurality of elements;
determining a location of an event in the environment, the location being described by the state data;
using the state data to establish a data communication path in the environment, wherein the data communication path is determined based on evaluating the state data, the location, and the event;
detecting a change to the data communication path; and
updating the environment and the data communication path by dynamically creating an alternate data communication path between the plurality of elements based on the change, the alternate data communication path being configured to route data among the plurality of elements, wherein each of the plurality of elements disposed along the data communication path has information associated with the alternate data communication path.
